(19) United States
(12) Patent Application Publication
(10) Pub. No.: US 2026/0362428 A1
(43) Pub. Date: Nov. 12, 2026

(54) METHOD AND APPARATUS FOR TRANSMITTING INDICATION INFORMATION AND READABLE STORAGE MEDIUM

(71) Applicant: BEIJING XIAOMI MOBILE SOFTWARE CO., LTD., Beijing (CN)

(72) Inventor: Ting FU, Beijing (CN)

(21) Appl. No.: 19/125,029

(22) PCT Filed: Oct. 31, 2022
(86) PCT No.: PCT/CN2022/128761

§ 371 Date: Apr. 28, 2025

(51) Int. Cl. H04W 72/21; H04W 72/115

(52) U.S. Cl. CPC H04W 72/21; H04W 72/115

(57) ABSTRACT

A method for sending indication information is performed by a user equipment. The method includes: in the case that a network device configures a configured grant Physical Uplink Shared Channel (CG-PUSCH) resource for the user equipment, sending indication information to the network device, wherein the indication information is configured to indicate the user equipment to release the CG-PUSCH resource.

### CROSS REFERENCE TO RELATED APPLICATIONS

The present disclosure is the U.S. national phase application of International Application No. PCT/CN2022/128761, filed on Oct. 31, 2022, the content of which is incorporated herein by reference in its entirety.

### TECHNICAL FIELD

The present disclosure relates to the field of wireless communication technology, in particular, to a method and an apparatus for transmitting indication information, and a readable storage medium.

### BACKGROUND

In Release 18 (R18) of the 3rd Generation Partnership Project (3GPP), one way to save energy consumption of the network device is to reduce unnecessary uplink reception. For example, if the terminal is configured semi-statically with uplink transmission resources, the user equipment (UE) may not transmit uplink information on each resource on these uplink transmission resources, and the network device needs to perform blind detection and reception.

### SUMMARY

In a first aspect, the present disclosure provides a method for sending indication information, performed by a user equipment, the method including: in the case that a network device configures a configured grant Physical Uplink Shared Channel (CG-PUSCH) resource for the user equipment, sending indication information to the network device, wherein the indication information is configured to indicate the user equipment to release the CG-PUSCH resource.

In a second aspect, the present disclosure provides a method for receiving indication information, performed by a network device, the method including: receiving indication information sent by a user equipment, wherein the indication information is configured to indicate the user equipment to release a CG-PUSCH resource; and stopping reception of a CG-PUSCH corresponding to the CG-PUSCH resource after receiving the indication information.

In a third aspect, the present disclosure provides a communication device including a processor and a memory. The memory is used to store computer programs. The processor is used to execute the computer program to implement the first aspect or any possible designs of the first aspect.

In a fourth aspect, the present disclosure provides a communication device including a processor and a memory. The memory is used to store computer programs. The processor is used to execute the computer program to implement the second aspect or any possible designs of the second aspect.

In a fifth aspect, the present disclosure provides a computer-readable storage medium storing instructions (or computer programs, programs), which when called and executed on a computer, cause the computer to execute the first aspect or any possible designs of the first aspect.

In a sixth aspect, the present disclosure provides a computer-readable storage medium storing instructions (or computer programs, programs), which when called and executed on a computer, cause the computer to execute any possible designs of the second aspect or the second aspect as described above.

It should be understood that the general description in the above and the detailed description in the following are only exemplary and explanatory, and cannot limit the present disclosure.

### BRIEF DESCRIPTION OF THE DRAWINGS

The drawings are incorporated into and constitute a part of this specification, which illustrate embodiments consistent with the present disclosure, and serve together with the specification to explain the principles of the present disclosure.

FIG. 1 is a schematic diagram of an architecture of a wireless communication system according to one or more embodiments of the present disclosure;

FIG. 2 is a flowchart of a method for transmitting indication information according to one or more embodiments of the present disclosure;

FIG. 3 is a flowchart of a method for sending indication information according to one or more embodiments of the present disclosure;

FIG. 4 is a schematic diagram of a valid starting time according to one or more embodiments of the present disclosure;

FIG. 5 is another schematic diagram of a valid starting time according to one or more embodiments of the present disclosure;

FIG. 6 is a flowchart of a method for receiving indication information according to one or more embodiments of the present disclosure;

FIG. 7 is a flowchart of a method for receiving indication information according to one or more embodiments of the present disclosure;

FIG. 8 is a block diagram of an apparatus for sending indication information according to one or more embodiments of the present disclosure;

FIG. 9 is a block diagram of a user equipment according to one or more embodiments of the present disclosure;

FIG. 10 is a block diagram of an apparatus for receiving indication information according to one or more embodiments of the present disclosure; and

FIG. 11 is a block diagram of a communication device according to one or more embodiments of the present disclosure.

### DETAILED DESCRIPTION

Detailed explanations of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

Terms used in present disclosure are for the purpose of describing specific embodiments only and are not intended to limit the present disclosure. Singular forms “a/an”, and “the” used in the present disclosure and the appended claims are also intended to include multiple forms, unless the context clearly indicates otherwise. It should also be understood that the term “and/or” used herein refers to and includes any or all possible combinations of one or more related items listed.

It should be understood that although various information may be described using terms such as first, second, third, etc. in the present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the word “if” and “provided” used herein can be interpreted as “when”, or “while”, or “in response to determination”, depending on the context.

Embodiments of the present disclosure will be described in the following in detail, examples of which are shown in the drawings, where the same or similar reference numerals indicate the same or similar elements throughout. The embodiments described below with reference to the drawings are exemplary and intended to explain the present disclosure, and should not be construed as limiting the present disclosure.

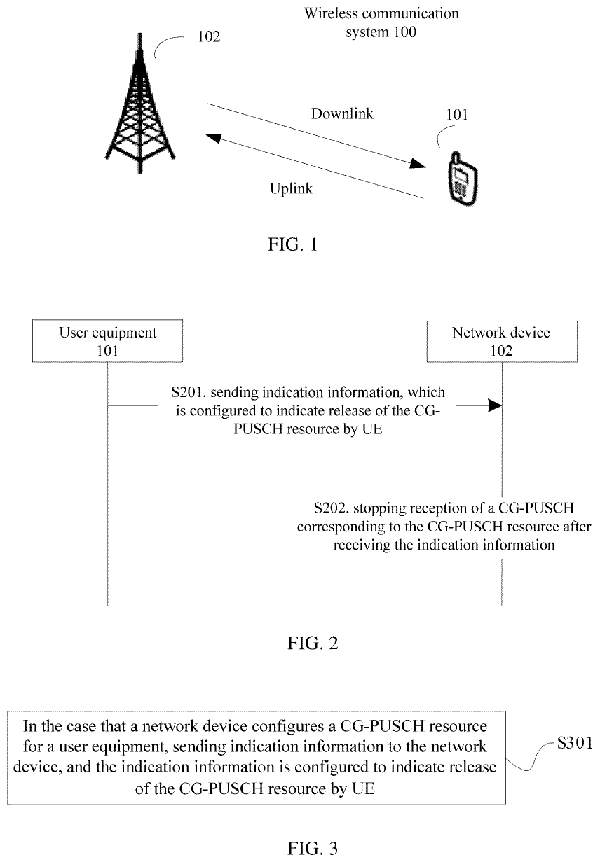

As shown in FIG. 1, a method for transmitting indication information provided by embodiments of the present disclosure can be applied to a wireless communication system 100. The wireless communication system can include a user equipment 101 and a network device 102. In some embodiments, the user equipment 101 is configured to support carrier aggregation and can be connected to multiple component carriers of the network device 102, including a primary component carrier and one or more secondary component carriers.

It should be understood that the above wireless communication system 100 can be applied to both low-frequency and high-frequency scenarios. The application scenarios of the wireless communication system 100 include but are not limited to Long Term Evolution (LTE) systems, LTE Frequency Division Duplex (FDD) systems, LTE Time Division Duplex (TDD) systems, Worldwide Interoperability for Microwave Access (WiMAX) communication systems, Cloud Radio Access Network (CRAN) systems, future 5th Generation (5G) systems, New Radio (NR) communication systems, or future evolved Public Land Mobile Network (PLMN) systems, etc.

The user equipment 101 described above can be a terminal, an access terminal, a terminal unit, a terminal station, a mobile station (MS), a remote station, a remote terminal, a mobile terminal, a wireless communication device, a terminal agent or a terminal device, etc. The user equipment 101 can have wireless transmission and reception capabilities, which can communicate (such as wirelessly communicate) with one or more network devices in one or more communication systems and receive network services provided by the network device. The network service here includes but is not limited to the network device 102 illustrated.

In some embodiments, the user equipment (UE) 101 can be a cellular phone, a cordless phone, a session initiation protocol (SIP) phone, a wireless local loop (WLL) station, a personal digital assistant (PDA) device, a handheld device with wireless communication capabilities, a computing device, other processing devices, onboard devices, and wearable devices that are connected to a wireless modem, a terminal device in the future 5G network, or a terminal device in the future evolved PLMN network.

The network device 102 can be an access network device (or an access network site). In some embodiments, the access network device refers to the device that can provide the network access function, for example, a radio access network (RAN) base station, etc. The network device 102 can include, for example, a base station (BS), or include a base station and a wireless resource management device for controlling the base station. The network device 102 can also include a relay station (a relay device), an access point, and base stations in future 5G networks, base stations in future evolved PLMN networks, or NR base stations, etc. The network device 102 can be a wearable device or an on-board device. The network device 102 can also be a communication chip with a communication module.

In some embodiments, the network device 102 includes but is not limited to next-generation base stations in 5G (gnodeB, gNB), evolved nodes in LTE systems (evolved node B, eNB), radio network controllers (RNC), nodes in WCDMA systems (node B, NB), wireless controllers and base station controllers (BSC) in CRAN systems, base transceiver stations (BTS) in GSM or CDMA systems, home base stations (e.g., home evolved node B, or home node B, HNB), baseband units (BBU), transmitting and receiving points (TRP), transmitting points (TP), or mobile switching centers, etc.

Embodiments of the present disclosure provide a method for transmitting indication information. As shown in FIG. 2, a method for transmitting indication information according to one or more embodiments is illustrated. As shown in FIG. 2, the method includes steps S201-S202, specifically explained as follows.

In step S201, in the case that a network device 102 configures a configured grant Physical Uplink Shared Channel (CG-PUSCH) resource for a user equipment 101, the user equipment 101 sends indication information to the network device 102, and the indication information is configured to indicate release of the CG-PUSCH resource by the user equipment 101.

In step S202, the network device 102 stops reception of a CG-PUSCH corresponding to the CG-PUSCH resource after receiving the indication information.

In some embodiments, the network device 102 can configure the configured grant Physical Uplink Shared Channel (CG-PUSCH) for the user equipment 101 using Radio Resource Control (RRC) signaling.

In some embodiments, the network device 102 can configure one or more sets of CG-PUSCHs for the user equipment 101, each set of CG-PUSCHs having a period and/or an initial offset different from another set of CG-PUSCHs.

In some embodiments, the user equipment 101 can transmit uplink data over the CG-PUSCH resource configured by the network device 102. The network device 102 performs the blind detection on the CG-PUSCH and receives the uplink data transmitted by the UE.

In some embodiments, the user equipment 101 sends configured grant Uplink Control Information (CG-UCI) in the CG-PUSCH in accompany with the uplink data.

In some embodiments, the user equipment 101 includes the indication information in the CG-UCI.

In some embodiments, the CG-UCI further includes process identification (ID) for Hybrid Automatic Repeat Request (HARQ), a redundancy version (RV), new data indication, and a channel sharing parameter (COT sharing), etc. In some embodiments, the new data indication is used to indicate whether the data is being transmitted for the first time or a retransmission.

In some embodiments, the user equipment 101 releases the CG-PUSCH resource, indicating that the configuration information corresponding to the CG-PUSCH resource will become invalid or deactivated, and the user equipment 101 will not use the CG-PUSCH to transmit the uplink data.

In some embodiments, when the network device 102 reconfigures the CG-PUSCH resource or reactivates the configuration information corresponding to the CG-PUSCH resource, the user equipment 101 can use the CG-PUSCH to transmit the uplink data again.

In embodiments of the present disclosure, the user equipment 101 notifies the network device 102, by sending the indication information to the network device 102, that the user equipment 101 will release the CG-PUSCH resource. So that the network device can stop the uplink reception of the CG-PUSCH according to the indication information, thereby stopping the unnecessary blind detection and the reception timely, and reducing the energy consumption of the network device.

Embodiments of the present disclosure provide a method for sending indication information, which is performed by the user equipment 101. FIG. 3 shows a method for sending indication information according to one or more embodiments of the present disclosure. As shown in FIG. 3, the method includes a step S301, specifically explained as follows.

In step S301, in the case that a network device 102 configures a configured grant Physical Uplink Shared Channel (CG-PUSCH) resource for a user equipment 101, the user equipment 101 sends indication information to the network device 102, and the indication information is configured to indicate release of the CG-PUSCH resource by the user equipment 101.

In some embodiments, the network device 102 can configure the CG-PUSCH for the user equipment 101 through the RRC signaling.

In some embodiments, the CG-PUSCH includes two types of CG-PUSCHs: Type 1 CG-PUSCH and Type 2 CG-PUSCH.

In some embodiments, the Type 1 CG-PUSCH is configured by the RRC signaling, and after the Type 1 CG-PUSCH is configured, the user equipment 101 can use the Type 1 CG-PUSCH resource for the uplink data transmission. In the related art, the network device 102 releases the resource configuration for this type of CG-PUSCH through the RRC reconfiguration.

The Type 2 CG-PUSCH is configured by the RRC signaling, and after the Type 2 CG-PUSCH is configured, the network device 102 needs to activate such configuration using Downlink Control Information (DCI) before the user equipment 101 can use the Type 2 CG-PUSCH resource for the uplink data transmission. In the related art, the network device 102 releases the resource configuration for this type of CG-PUSCH by sending deactivated DCI.

In some embodiments, if the user equipment 101 sends the indication information, it indicates that the CG-PUSCH resource will be released. For example, the uplink data transmission performed by the user equipment 101 this time may have already been completed.

In some embodiments, the network device 102 can stop the blind detection and the reception of the CG-PUSCH after receiving the indication information, to save the energy consumption.

In embodiments of the present disclosure, the user equipment 101 notifies the network device 102, by sending the indication information to the network device 102, that the user equipment 101 will release the CG-PUSCH resource. So that the network device can stop the uplink reception of the CG-PUSCH according to the indication information, thereby stopping the unnecessary blind detection and the reception timely, and reducing the energy consumption of the network device.

Embodiments of the present disclosure provide a method for sending indication information, which is performed by the user equipment 101. The method includes a step S301a, specifically explained as follows.

In step S301a (not shown), in the case that a network device 102 configures a CG-Attorney PUSCH resource for a user equipment 101, the user equipment 101 includes configured grant Uplink Control Information (CG-UCI) in the CG-PUSCH, and the CG-UCI includes indication information.

In some embodiments, the indication information is configured to indicate release of the CG-PUSCH resource by the user equipment 101.

In some embodiments, the CG-UCI further includes process identification for HARQ, a redundancy version, new data indication, and a channel sharing parameter, etc. In some embodiments, the new data indication is used to indicate whether the data is being transmitted for the first time or a retransmission.

In some embodiments, the indication information can occupy one or several bits.

In some embodiments, taking that the indication information occupies one bit as an example, when the bit value is 1, it indicates that the user equipment 101 will release the CG-PUSCH resource.

According to embodiments of the present disclosure, the user equipment 101 includes the indication information in the CG-UCI sent in accompany with the data in the CG-PUSCH, so that the network device can learn whether the UE sends the indication information when the network device blindly detects and receives the CG-UCI, so as to stop the blind detection and the reception timely to achieve the energy saving.

Embodiments of the present disclosure provide a method for sending indication information, which is performed by the user equipment 101. The method includes a step S301, specifically explained as follows.

In step S301, in the case that a network device 102 configures a CG-PUSCH resource for a user equipment 101, the user equipment 101 sends indication information to the network device 102, and the indication information is configured to indicate release of the CG-PUSCH resource by the user equipment 101.

In some embodiments, when the CG-PUSCH is a first type of CG-PUSCH, the configuration information corresponding to the resource for the first type of CG-PUSCH becomes invalid after the indication information is sent.

In some embodiments, the user equipment 101 includes the indication information in the CG-UCI sent in accompany in the CG-PUSCH.

In some embodiments, for the first type of CG-PUSCH (Type 1), the network device 102 configures the resource for this type of CG-PUSCH through the RRC signaling, and after the resource for the first type of CG-PUSCH is configured, the user equipment 101 can use the configured CG-PUSCH for the uplink data transmission.

In some embodiments, the network device 102 sends the configuration information corresponding to the Type 1 CG-PUSCH through the RRC signaling, to configure time-frequency resources for the Type 1 CG-PUSCH. After receiving the configuration information, the user equipment 101 performs the uplink data transmission through the CG-PUSCH based on the configuration information.

In some embodiments, the configuration information corresponding to the resource for the first type of CG-PUSCH becomes invalid from a time when the user equipment 101 sends the indication information.

In some embodiments, the user equipment 101 no longer applies the configuration information from the time when the user equipment 101 sends the indication information, and does not send the uplink data over the resource for the first type of CG-PUSCH after such sending time. After receiving the indication information, the network device 102 learns that the configuration information has become invalid, and the user equipment 101 has released the resource for the first type of CG-PUSCH. Therefore, the network device 102 can stop the uplink reception of the first type of CG-PUSCH after receiving the indication information. In some embodiments, the time when the user equipment 101 determines that the configuration information is invalid is earlier than the time when the network device 102 learns that the configuration information has become invalid.

In some embodiments, the configuration information corresponding to the resource for the first type of CG-PUSCH becomes invalid from a time postponed from the time when the indication information is sent by a set duration.

In some embodiments, the set duration can be the duration specified in the protocol or defined by the user equipment 101 itself. For example, the set duration is a duration during which the user equipment 101 considers that the indication information can be received by the network device 102. In some other embodiments, the set duration may or may not be equal to a first duration in the following embodiments. When the set duration is equal to the first duration, the set duration can include a processing time that the network device 102 uses to process the indication information.

According to the embodiments, the user equipment 101 no longer applies the configuration information from the time postponed from the sending time by a set duration, and does not send the uplink data over the resource for the first type of CG-PUSCH after the sending time. After receiving the indication information, the network device 102 learns that the configuration information has become invalid, and the user equipment 101 has released the resource for the first type of CG-PUSCH. Therefore, the network device 102 can stop the uplink reception of the first type of CG-PUSCH after receiving the indication information.

In some embodiments, the configuration information corresponding to the first type of CG-PUSCH becomes invalid when the indication information is received by the network device 102.

In some embodiments, the network device 102 can provide the corresponding feedback upon receiving the indication information. When the indication information is received, the user equipment 101 no longer applies the configuration information and does not send the uplink data over the resource for the first type of CG-PUSCH after the sending time. At the same time, the network device 102 stops the uplink reception of the first type of CG-PUSCH after receiving the indication information.

In some embodiments, the network device 102 can stop the reception of the CG-PUSCH after receiving the indication information, and does not need to send the RRC reconfiguration message to release the resource configuration for the first type of CG-PUSCH.

In some embodiments, when the network device 102 reconfigures the configuration information corresponding to the Type 1 CG-PUSCH, the user equipment 101 can transmit the uplink data through the Type 1 CG-PUSCH again.

According to embodiments of the present disclosure, for the first type of CG-PUSCH, the configuration information corresponding to the resource for the first type of CG-PUSCH become invalid after the user equipment 101 sends the indication information. Therefore, the network device 102 can stop the reception of the CG-PUSCH after receiving the indication information, which can save the energy consumption, as well as saving the signaling from the network device 102.

Embodiments of the present disclosure provide a method for sending indication information, which is performed by the user equipment 101. The method includes a step S301, specifically explained as follows.

In step S301, in the case that a network device 102 configures a CG-PUSCH resource for a user equipment 101, the user equipment 101 sends indication information to the network device 102, and the indication information is configured to indicate release of the CG-PUSCH resource by the user equipment 101.

In some embodiments, when the CG-PUSCH is a second type of CG-PUSCH, the configuration information corresponding to the resource for the second type of CG-PUSCH is deactivated after the indication information is sent.

In some embodiments, the user equipment 101 includes the indication information in the CG-UCI sent in accompany in the CG-PUSCH.

In some embodiments, the second type of CG-PUSCH (Type 2) is configured by the RRC signaling, and after the second type of CG-PUSCH is configured, the network device 102 needs to activate the configuration by using the Downlink Control Information (DCI) before the user equipment 101 can use the Type 2 CG-PUSCH resource for the uplink data transmission.

In some embodiments, the network device 102 sends the configuration information corresponding to the Type 2 CG-PUSCH through the RRC signaling, to configure time-frequency resources for the Type 2 CG-PUSCH, and sends the DCI to activate the configuration information, so that the user equipment 101 can perform the data transmission based on the configuration information.

In some embodiments, the configuration information corresponding to the Type 2 CG-PUSCH is deactivated from a time when the user equipment 101 sends the indication information. In some embodiments, the user equipment 101 no longer applies the configuration information from the time when the user equipment 101 sends the indication information, and does not send the uplink data over the resource for the second type of CG-PUSCH after such sending time. After receiving the indication information, the network device 102 learns that the configuration information has been deactivated, and the user equipment 101 has released the resource for the second type of CG-PUSCH. Therefore, the network device 102 can stop the uplink reception of the second type of CG-PUSCH after receiving the indication information, and does not need to send the DCI for indicating deactivating again.

In some embodiments, the configuration information corresponding to the Type 2 CG-PUSCH is deactivated from a time postponed from the time when the indication information is sent by a set duration. In some embodiments, the user equipment 101 no longer applies the configuration information from the time postponed from the sending time by a set duration, and does not send the uplink data over the resource for the second type of CG-PUSCH after the sending time. After receiving the indication information, the network device 102 learns that the configuration information has been deactivated, and the user equipment 101 has released the resource for the second type of CG-PUSCH. Therefore, the network device 102 can stop the uplink reception of the second type of CG-PUSCH after receiving the indication information, and does not need to send the DCI for indicating deactivating again.

In some embodiments, the configuration information corresponding to the Type 2 CG-PUSCH is deactivated when the indication information is received by the network device 102. In some embodiments, the network device 102 can provide the corresponding feedback upon receiving the indication information. When the indication information is received, the user equipment 101 no longer applies the configuration information and does not send the uplink data over the resource for the second type of CG-PUSCH after the sending time. At the same time, the network device 102 stops the uplink reception of the second type of CG-PUSCH after receiving the indication information.

In some embodiments, the network device 102 can stop the reception of the CG-PUSCH after receiving the indication information, and does not need to send deactivated DCI to deactivate the resource configuration for the second type of CG-PUSCH.

In some embodiments, when the network device 102 sends the DCI configured for activating the configuration information corresponding to the Type 2 CG-PUSCH again, the user equipment 101 can transmit the uplink data through the Type 2 CG-PUSCH again.

According to embodiments of the present disclosure, for the second type of CG-PUSCH, the configuration information corresponding to the resource for the second type of CG-PUSCH is deactivated after the user equipment 101 sends the indication information. Therefore, the network device 102 can stop the reception of the CG-PUSCH after receiving the indication information, which can save the energy consumption, as well as saving the signaling from the network device 102.

Embodiments of the present disclosure provide a method for sending indication information, which is performed by the user equipment 101. The method includes a step S301, specifically explained as follows.

In step S301, in the case that a network device 102 configures a CG-PUSCH resource for a user equipment 101, the user equipment 101 sends indication information to the network device 102, and the indication information is configured to indicate release of the CG-PUSCH resource by the user equipment 101.

In some embodiments, when the network device 102 configures multiple sets of CG-PUSCH resources for the user equipment 101, the indication information is configured to indicate the release of all CG-PUSCH resources.

In some embodiments, the user equipment 101 includes the indication information in the CG-UCI sent in accompany in the CG-PUSCH.

In some embodiments, the network device 102 configures multiple sets of CG-PUSCHs, with different periods and/or initial offsets.

In some embodiments, the multiple sets of CG-PUSCHs can be the first type of CG-PUSCH (Type 1).

In some embodiments, the multiple sets of CG-PUSCHs can be the second type of CG-PUSCH (Type 2).

In some embodiments, the multiple sets of CG-PUSCHs include the first type of CG-PUSCH (Type 1) and the second type of CG-PUSCH (Type 2), where different types of CG-PUSCHs can be assigned and configured.

In some embodiments of the present disclosure, the indication information is applicable to all CG-PUSCHs configured by the network device 102, so that after the user equipment 101 sends the indication information, all CG-PUSCH resources will be released. After receiving the instruction information, the network device 102 can stop the reception of all CG-PUSCHs.

Embodiments of the present disclosure provide a method for sending indication information, which is performed by the user equipment 101. The method includes a step S301, specifically explained as follows.

In step S301, in the case that a network device 102 configures a CG-PUSCH resource for a user equipment 101, the user equipment 101 sends indication information to the network device 102, and the indication information is configured to indicate release of the CG-PUSCH resource by the user equipment 101.

In some embodiments, when the network device 102 configures multiple sets of CG-PUSCH resources for the user equipment 101, the indication information is configured to indicate the release of CG-PUSCH resources for a first part of CG-PUSCHs.

In some embodiments, the user equipment 101 includes the indication information in the CG-UCI sent in accompany in the CG-PUSCH.

In some embodiments, the first part of CG-PUSCHs can be one or more than one CG-PUSCH among the multiple sets of CG-PUSCHs.

In some embodiments, the indication information includes indication for determining the first part of CG-PUSCHs, that is, the first part of CG-PUSCHs can be determined based on the indication information.

In some embodiments, the indication information includes N bits, and the N bits are used to indicate an index of a carrier to which the first part of CG-PUSCHs belong.

In some embodiments, the value of N can be greater than or equal to 1.

In some embodiments, the N bits can indicate one or more carriers, and all CG-PUSCHs on the indicated one or more carriers are the first part of CG-PUSCHs.

In some embodiments, one bit is used to indicate two carriers. When the bit is 1, it corresponds to the first carrier, and when the bit is 0, it corresponds to the second carrier. The network device 102 can determine the carrier indicated by the indication information based on the value of the bit in the indication information, and all CG-PUSCHs on the carrier(s) are the first part of CG-PUSCHs.

In some embodiments, two bits are used to indicate the carriers, each bit in the two bits indicating a carrier respectively. For example, when the values of the two bits are 11, it corresponds to the first carrier and the second carrier. When the values of the two bits are 10,it corresponds to the first carrier. When the values of the two bits are 01, it corresponds to the second carrier. The network device 102 can determine the carrier indicated by the indication information based on the values of the two bits in the indication information, and all CG-PUSCHs on the indicated carrier(s) are the first part of CG-PUSCHs.

It can be understood that the above bit indication is only for illustration and not for limitation, and multiple carriers can also be indicated based on more bits correspondingly.

In some embodiments, the indication information includes N bits, and the N bits are used to indicate an index of configuration information corresponding to the first part of CG-PUSCHs.

In some embodiments, in the case where the network device 102 configures multiple sets of CG-PUSCHs for the user equipment 101, the configuration information corresponding to each set of CG-PUSCHs has a corresponding index.

In some embodiments, the value of N can be greater than or equal to 1.

In some embodiments, the network device 102 can determine the index of the configuration information based on the N bits, and then determines the first part of CG-PUSCHs corresponding to the configuration information.

In some embodiments, when N is equal to 1, the index of the corresponding configuration information is determined based on the different values of this one bit. When the bit is 1, it corresponds to the first configuration information. When the bit is 0, it corresponds to the second configuration information. The network device 102 can determine the configuration information indicated by the indication information based on the value of the bit in the indication information, and then determines the CG-PUSCH(s) corresponding to the configuration information.

In some embodiments, when N is equal to 2, each bit in the two bits can indicate a piece of configuration information respectively, or different values of the two bits can indicate different configuration information.

When each bit in the two bits can indicate a piece of configuration information respectively, it is assumed as follows: the two bits being of 11 corresponds to the first configuration information and the second configuration information, the two bits being of 10 corresponds to the first configuration information, and the two bits being of 01 corresponds to the second configuration information.

When different values of the two bits are used to indicate different configuration information, it is assumed as follows: the two bits being of 11 corresponds to the first configuration information, the two bits being of 10 corresponds to the second configuration information, the two bits being of 01 corresponds to the third configuration information, and the two bits being of 00 corresponds to the fourth configuration information.

The above description is for illustration only, and more bits can be used to indicate more configuration information.

In some embodiments, the first part of CG-PUSCHs include a first CG-PUSCH including the indication information.

In some embodiments, the user equipment 101 includes the indication information in the CG-UCI sent in accompany in the first CG-PUSCH, and the indication information is applicable to the first CG-PUSCH, that is, the user equipment 101 will release the resources for the first CG-PUSCH.

In some embodiments, as shown in FIG. 5, it is assumed that the indication information is included in a first one among a plurality of the first CG-PUSCHs, after an ending time t1 of the first one among the plurality of the first CG-PUSCHs, the user equipment 101 can release the resources for each first CG-PUSCH corresponding to shaded portions, and may not release the resources for a second CG-PUSCH corresponding to non-shaded portions.

In some embodiments, after receiving the indication information, the network device 102 stops the reception of the first CG-PUSCH after the time t1 and can continue the reception of the second CG-PUSCH or other CG-PUSCHs.

In some embodiments, the first part of CG-PUSCHs include the first CG-PUSCH including the indication information, and a second CG-PUSCH having the same characteristic parameter(s) as the first CG-PUSCH.

In some embodiments, the second CG-PUSCH can be one or more than one CG-PUSCH.

In some embodiments, the user equipment 101 includes the indication information in the CG-UCI sent in accompany in the first CG-PUSCH. The indication information is applicable to both the first CG-PUSCH and the second CG-PUSCH, that is, the user equipment 101 will release the resources for the first CG-PUSCH and the second CG-PUSCH.

In some embodiments, as shown in FIG. 5, the first CG-PUSCH and the second CG-PUSCH have the same periods but different initial offsets. It is assumed that the indication information is included in the first one among the plurality of the first CG-PUSCHs, after an ending time t1 of the first one among the plurality of the first CG-PUSCHs, the user equipment 101 can release the resources for the first CG-PUSCH corresponding to shaded portions, as well as the resources for the second CG-PUSCH corresponding to non-shaded portions.

In some embodiments, after receiving the indication information, the network device 102 stops the reception of the first CG-PUSCH and the second CG-PUSCH after the time t1. If there are other corresponding CG-PUSCH resources, the network device 102 can continue the reception of other CG-PUSCHs.

In some embodiments, the characteristic parameters include at least one of the following:
a period of the CG-PUSCH;
a group identifier of the CG-PUSCH;
a priority identifier of the CG-PUSCH.

In some embodiments, the period of the second CG-PUSCH is the same as the period of the first CG-PUSCH, indicating that the indication information is applicable to both the first CG-PUSCH and the second CG-PUSCH.

In some embodiments, the priority identifier of the second CG-PUSCH is the same as the priority identifier of the first CG-PUSCH, indicating that the indication information is applicable to both the first CG-PUSCH and the second CG-PUSCH.

In some embodiments, the group identifier of the second CG-PUSCH is the same as the group identifier of the first CG-PUSCH, indicating that the indication information is applicable to both the first CG-PUSCH and the second CG-PUSCH.

In some embodiments, the group identifier of each set of CG-PUSCHs is included in the configuration information corresponding to the CG-PUSCHs. For multiple sets of CG-PUSCHs having the same group identifier, the initial offsets of the multiple sets of CG-PUSCHs may be different, while other parameters may be the same. The multiple CG-PUSCHs having the same group identifier are used to transmit the same business flow.

For example, the first CG-PUSCH is denoted as CG-PUSCH Config 1, and the second CG-PUSCH includes CG-PUSCH Config 2 and CG-PUSCH Config 3. When the group identifiers of the CG-PUSCH Config 1, the CG-PUSCH Config 2, and the CG-PUSCH Config 3 are the same, it indicates that these three CG-PUSCHs are used for the same business flow. The indication information is applicable to these three CG-PUSCHs.

In embodiments of the present disclosure, the indication information sent by the user equipment 101 may be applicable to one or more CG-PUSCHs, so that the network device 102 can stop the reception of the one or more CG-PUSCHs, so as to save the energy consumption.

Embodiments of the present disclosure provide a method for sending indication information, which is performed by the user equipment 101. The method includes a step S301, specifically explained as follows.

In step S301, in the case that a network device 102 configures a CG-PUSCH resource for a user equipment 101, the user equipment 101 sends indication information to the network device 102, and the indication information is configured to indicate release of the CG-PUSCH resource by the user equipment 101.

In some embodiments, a valid starting time of the indication information is one of the following:
an ending time of the first CG-PUSCH including the indication information;
a time postponed from the ending time of the first CG-PUSCH by a first duration.

In some embodiments, the user equipment 101 includes the indication information in the CG-UCI sent in accompany in the first CG-PUSCH.

In some embodiments, the CG-PUSCH resources indicated to be released in the indication information can be either the resource for the first type of CG-PUSCH or the resource for the second type of CG-PUSCH.

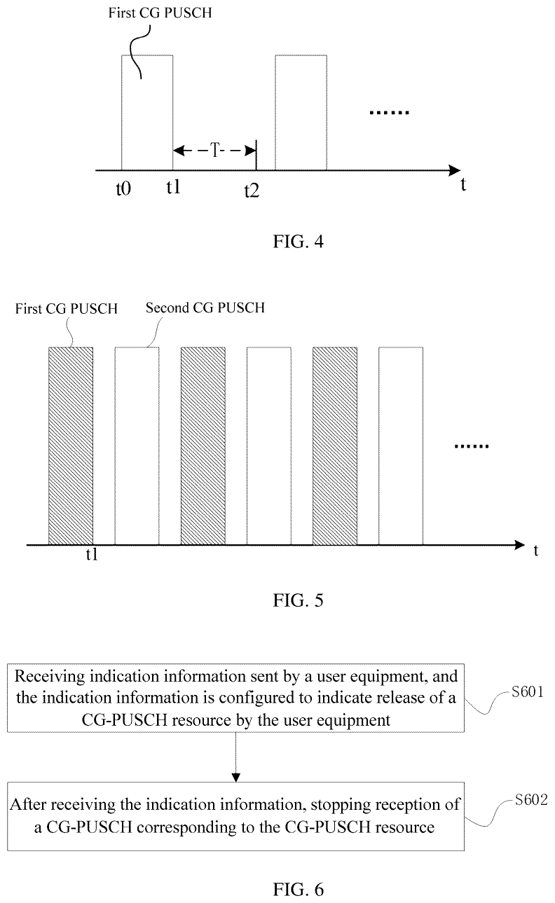

In some embodiments, as shown in FIG. 4, the CG-PUSCH including the indication information is the first CG-PUSCH. The valid starting time of the indication information is the ending time t1 of the first CG-PUSCH including the indication information. That is, the user equipment 101 will release the CG-PUSCH resources from time t1, and the network device 102 will not receive other CG-PUSCHs from time t1.

It should be noted that, due to the periodicity of the first CG-PUSCH, the indication information may be included in any first CG-PUSCH, and t1 is the ending time of the first CG-PUSCH including the indication information. For example, in the example of FIG. 4, if the indication information is included in the first one among the plurality of the first CG-PUSCHs, then t1 is the ending time of the first one CG-PUSCH among the plurality of the first CG-PUSCHs.

In some embodiments, if the indication information indicates that the resource for the first type of CG-PUSCH is released, the configuration information corresponding to the resource for the first type of CG-PUSCH can become invalid at any of the following time:
a sending time of the indication information;
a time postponed from the sending time of the indication information by a set duration;
a time when the indication information is received by network device 102;
an ending time t1 of the first CG-PUSCH including the indication information.

In some embodiments, as shown in FIG. 4 or FIG. 5, the sending time of the indication information may be within the duration of the first CG-PUSCH, that is, within a range of [t0, t1]. For example, the sending time may be earlier than t1 or later than t0. The set duration can be equal to or less than a first duration. For example, the time postponed from the sending time by the set duration may be within a range of [t1, t2]. The time when the indication information is received by the network device 102 may be, for example, within a range of [t1, t2], or between two adjacent CG-PUSCHs.

In some embodiments, if the indication information indicates that the resource for the second type of CG-PUSCH is released, the configuration information corresponding to the resource for the second type of CG-PUSCH can be deactivated at any of the following time:
a sending time of the indication information;
a time postponed from the sending time of the indication information by a set duration;
a time when the indication information is received by network device 102;
an ending time t1 of the first CG-PUSCH including the indication information.

In some embodiments, as shown in FIG. 4 or FIG. 5, the sending time of the indication information may be within the duration of the first CG-PUSCH, that is, within a range of [t0, t1]. For example, the sending time may be earlier than t1 or later than t0. The set duration can be equal to or less than a first duration. For example, the time postponed from the sending time by the set duration may be within a range of [t1, t2]. The time when the indication information is received by the network device 102 may be, for example, within a range of [t1, t2], or between two adjacent CG-PUSCHs.

In some embodiments, as shown in FIG. 4, the CG-PUSCH including the indication information is the first CG-PUSCH. The valid starting time of the indication information is time t2 which is postponed from the ending time of the first CG-PUSCH by the first duration T1. That is, the user equipment 101 releases the CG-PUSCH resources from time t2, and the network device 102 does not receive other CG-PUSCHs from time t2.

In some embodiments, the first duration T1 can include the processing time that the network device 102 uses to process the indication information.

In some embodiments, if the indication information indicates that the resource for the first type of CG-PUSCH is released, the configuration information corresponding to the resource for the first type of CG-PUSCH can become invalid at any of the following time:
a sending time of the indication information;
a time postponed from the sending time of the indication information by a set duration;
a time when the indication information is received by network device 102;
a time t2.

In some embodiments, as shown in FIG. 4 or FIG. 5, the sending time of the indication information may be within the duration of the first CG-PUSCH, that is, within a range of [t0, t1]. For example, the sending time may be earlier than t1 or later than t0. The set duration can be equal to or less than a first duration. For example, the time postponed from the sending time by the set duration may be within a range of [t1, t2]. The time when the indication information is received by the network device 102 may be, for example, within a range of [t1, t2], or between two adjacent CG-PUSCHs.

In some embodiments, if the indication information indicates that the resource for the second type of CG-PUSCH is released, the configuration information corresponding to the resource for the second type of CG-PUSCH can be deactivated at any of the following time:
a sending time of the indication information;
a time postponed from the sending time of the indication information by a set duration;
a time when the indication information is received by network device 102;
a time t2.

In some embodiments, as shown in FIG. 4 or FIG. 5, the sending time of the indication information may be within the duration of the first CG-PUSCH, that is, within a range of [t0, t1]. For example, the sending time may be earlier than t1 or later than t0. The set duration can be equal to or less than a first duration. For example, the time postponed from the sending time by the set duration may be within a range of [t1, t2]. The time when the indication information is received by the network device 102 may be, for example, within a range of [t1, t2], or between two adjacent CG-PUSCHs.

In embodiments of the present disclosure, the indication information sent by the user equipment 101 may correspond to different valid starting time, and the network device 102 stops the reception of the CG-PUSCH based on the corresponding valid starting time.

Embodiments of the present disclosure provide a method for receiving indication information, which is performed by the network device 102. FIG. 6 shows a method for receiving indication information according to one or more embodiments of the present disclosure. As shown in FIG. 6, the method includes steps S601-S602, specifically explained as follows.

In step S601, a network device 102 receives indication information sent by a user equipment 101, and the indication information is configured to indicate release of a CG-PUSCH resource by the user equipment 101.

In step S602, after receiving the indication information, the network device 102 stops reception of a CG-PUSCH corresponding to the CG-PUSCH resource.

In some embodiments, the network device 102 can configure the CG-PUSCH for the user equipment 101 using the RRC signaling. In some embodiments, the network device 102 can configure one or more sets of CG-PUSCHs for the user equipment 101, each set of CG-PUSCHs having a period and/or an initial offset different from another set of CG-PUSCHs.

In some embodiments, the CG-PUSCH includes two types of CG-PUSCHs: a first type of CG-PUSCH (Type 1) and a second type of CG-PUSCH (Type 2).

In some embodiments, the user equipment 101 includes the indication information in the CG-UCI sent in accompany in the CG-PUSCH.

In some embodiments, the step S601 can include the following step S601a, specifically explained as follows.

In step S601a (not shown), the network device 102 receives CG-UCI included in the CG-PUSCH, and the CG-UCI includes indication information.

In some embodiments, the CG-UCI further includes process identification for HARQ, a redundancy version, new data indication, and a channel sharing parameter, etc. In some embodiments, the new data indication is used to indicate whether the data is being transmitted for the first time or a retransmission.

According to embodiments of the present disclosure, based on the indication information sent by the user equipment 101, the network device 102 learns that the user equipment 101 will release the CG-PUSCH resource, and thus, based on the indication information, the network device 102 can stop the uplink reception of the CG-PUSCH, as well as stopping the unnecessary blind detection and the reception, reducing the energy consumption of the network device.

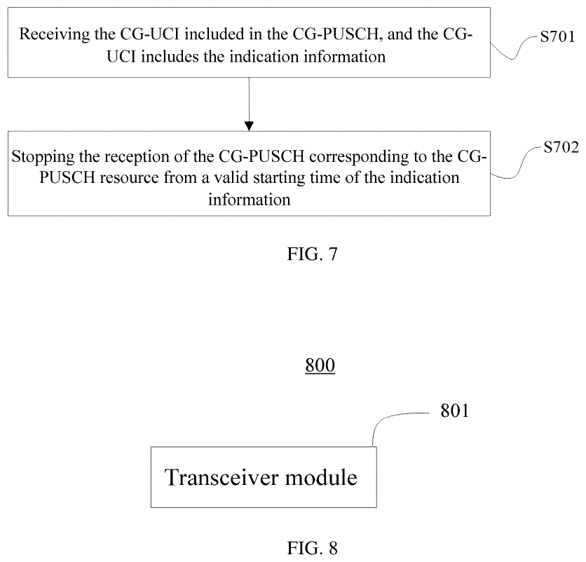

Embodiments of the present disclosure provide a method for receiving indication information, which is performed by the network device 102. FIG. 7 is a method for receiving indication information according to one or more embodiments of the present disclosure. As shown in FIG. 7, the method includes steps S701-S702, specifically explained as follows.

In step S701, the network device 102 receives the CG-UCI included in the CG-PUSCH, and the CG-UCI includes the indication information. In some embodiments, the indication information is configured to indicate release of a CG-PUSCH resource by the user equipment 101.

In step S702, the network device 102 stops the reception of the CG-PUSCH corresponding to the CG-PUSCH resource from a valid starting time of the indication information.

In some embodiments, the user equipment 101 includes the indication information in the CG-UCI sent in accompany in the CG-PUSCH.

In some embodiments, the valid starting time is one of the following:
an ending time of the first CG-PUSCH including the indication information;
a time postponed from the ending time of the first CG-PUSCH by a first duration.

In some embodiments, as shown in FIG. 4, the CG-PUSCH including the indication information is the first CG-PUSCH. The valid starting time of the indication information is the ending time t1 of the first CG-PUSCH including the indication information. That is, the user equipment 101 will release the CG-PUSCH resource from time t1, and the network device 102 will not receive other CG-PUSCHs from time t1.

In some embodiments, as shown in FIG. 4, the CG-PUSCH including the indication information is the first CG-PUSCH. The valid starting time of the indication information is time t2 which is postponed from the ending time of the first CG-PUSCH by the first duration T1. That is, the user equipment 101 releases the CG-PUSCH resources from time t2, and the network device 102 does not receive other CG-PUSCHs from time t2.

In some embodiments, the first duration T1 can include the processing time that the network device 102 uses to process the indication information.

According to embodiments of the present disclosure, the network device 102 can stop the reception of the CG-PUSCH at an appropriate time after receiving the indication information, so as to save the energy consumption of itself.

Embodiments of the present disclosure provide a method for receiving indication information, which is performed by the network device 102.

The method includes steps S601-S603, specifically explained as follows.

In step S601, a network device 102 receives indication information sent by a user equipment 101, and the indication information is configured to indicate release of a CG-PUSCH resource by the user equipment 101.

In step S602, the network device 102 stops reception of a CG-PUSCH corresponding to the CG-PUSCH resource after receiving the indication information.

In step S603, when the CG-PUSCH is a second type of CG-PUSCH, the network device 102 does not send, after receiving the indication information, the Downlink Control Information (DCI) configured to deactivate configuration information corresponding to the CG-PUSCH.

In some embodiments, the execution order of steps S602 and S603 is only for illustration, and the two steps can also be executed synchronously.

In some embodiments, the method can include steps S701-S703, specifically explained as follows.

In step S701, the network device 102 receives the CG-UCI sent in accompany in the CG-PUSCH, and the CG-UCI includes the indication information. In some embodiments, the indication information is configured to indicate release of a CG-PUSCH resource by the user equipment 101.

In step S702, the network device 102 stops the reception of the CG-PUSCH corresponding to the CG-PUSCH resource from a valid starting time of the indication information.

In step S703, when the CG-PUSCH is a second type of CG-PUSCH, the network device 102 does not send, after receiving the indication information, the Downlink Control Information (DCI) configured to deactivate configuration information corresponding to the CG-PUSCH.

In some embodiments, the execution order of steps S702 and S703 is only for illustration, and the two steps can also be executed synchronously.

In some embodiments, the valid starting time is one of the following:
an ending time of a first CG-PUSCH including the indication information;
a time postponed from the ending time of the first CG-PUSCH by a first duration.

According to embodiments of the present disclosure, after sending the indication information, the user equipment 101 indicates that the CG-PUSCH resources will be released, and the network device 102 does not need to send deactivated DCI to deactivate the resource configuration for the second type of CG-PUSCH, saving the energy while saving the signaling.

In some embodiments, when the CG-PUSCH is a first type of CG-PUSCH, the method can further include step S603a or step S703a (not shown), that is, when the CG-PUSCH is the first type of CG-PUSCH, the network device 102 does not send, after receiving the indication information, RRC reconfiguration messages to release the resource configuration for the first type of CG-PUSCH. Therefore, the network device 102 can stop the reception of the CG-PUSCH after receiving the indication information, which can save the energy consumption and the signaling of the network device 102.

Embodiments of the present disclosure provide a method for receiving indication information, which is performed by the network device 102. The method includes steps S601-S602a, specifically explained as follows.

In step S601, the network device 102 receives the indication information sent by the user equipment 101, and the indication information is configured to indicate release of the CG-PUSCH resource by the user equipment 101.

In step S602a (not shown), the network device 102 stops the uplink reception of all CG-PUSCHs configured by the network device after receiving the indication information.

In some embodiments, the indication information is configured to indicate the release of all CG-PUSCH resources.

In some embodiments, the user equipment 101 includes the indication information in the CG-UCI sent in accompany in the CG-PUSCH.

According to embodiments of the present disclosure, in a scenario where the network device 102 configures multiple sets of CG-PUSCHs for the user equipment 101, the indication information sent by the user equipment 101 can be applied to all CG-PUSCHs. After receiving the indication information, the network device 102 can stop the reception of all CG-PUSCHs, so as to save the energy consumption.

Embodiments of the present disclosure provide a method for receiving indication information, which is performed by the network device 102. The method includes steps S601-S602b, specifically explained as follows.

In step S601, the network device 102 receives the indication information sent by the user equipment 101, and the indication information is configured to indicate release of the CG-PUSCH resource by the user equipment 101.

In step S602b (not shown), the network device 102 stops the uplink reception of a first part of CG-PUSCHs after receiving the indication information.

In some embodiments, the indication information is configured to indicate the release of CG-PUSCH resources for the first part of CG-PUSCHs.

In some embodiments, the user equipment 101 includes the indication information in the CG-UCI sent in accompany in the CG-PUSCH.

In some embodiments, the first part of CG-PUSCHs can be one or more than one CG-PUSCH among the multiple sets of CG-PUSCHs.

In some embodiments, the indication information includes indication for determining the first part of CG-PUSCHs. The network device 102 determines the first part of CG-PUSCHs based on the indication information.

In some embodiments, before step S602b, the method can further include the following step S602-1, specifically explained as follows.

In step S602-1, the network device 102 determines the first part of CG-PUSCHs based on the indication information.

In some embodiments, the indication information includes N bits, and the N bits are used to indicate an index of a carrier to which the first part of CG-PUSCHs belong.

In some embodiments, the value of N can be greater than or equal to 1.

In some embodiments, the N bits can indicate one or more carriers.

In some embodiments, after the network device 102 determines the index(es) of one or more carriers based on the indication information, all CG-PUSCHs on the one or more carriers are the first part of CG-PUSCHs.

In some embodiments, in the indication information, one bit is used to indicate two carriers. When the bit is 1, it corresponds to the first carrier, and when the bit is 0, it corresponds to the second carrier. The network device 102 can determine the carrier indicated by the indication information based on the value of the bit in the indication information, and all CG-PUSCHs on the carrier(s) are the first part of CG-PUSCHs.

It can be understood that the above bit indication is only for illustration and not for limitation, and multiple carriers can also be indicated based on more bits correspondingly.

In some embodiments, the indication information includes N bits, and the N bits are used to indicate an index of configuration information corresponding to the first part of CG-PUSCHs.

In some embodiments, in the case where the network device 102 configures multiple sets of CG-PUSCHs for the user equipment 101, the configuration information corresponding to each set of CG-PUSCHs has a corresponding index.

In some embodiments, the value of N can be greater than or equal to 1.

In some embodiments, the network device 102 can determine the index of the configuration information based on the N bits, and then determines the first part of CG-PUSCHs corresponding to the configuration information.

In some embodiments, when N is equal to 1, the index of the corresponding configuration information is determined based on the different values of this one bit. When the bit is 1, it corresponds to the first configuration information. When the bit is 0, it corresponds to the second configuration information. The network device 102 can determine the configuration information indicated by the indication information based on the value of the bit in the indication information, and then determines the CG-PUSCH(s) corresponding to the configuration information.

In some embodiments, the first part of CG-PUSCHs include at least one of the following:
a first CG-PUSCH including the indication information;
a second CG-PUSCH having the same characteristic parameter(s) as the first CG-PUSCH.

In some embodiments, the user equipment 101 includes the indication information in the CG-UCI sent in accompany in the first CG-PUSCH.

In some embodiments, the indication information is applicable to the first CG-PUSCH.

As shown in FIG. 5, it is assumed that the indication information is included in a first one among a plurality of the first CG-PUSCHs, and after an ending time t1 of the first one among the plurality of the first CG-PUSCHs, the user equipment 101 can release the resources for each first CG-PUSCH corresponding to shaded portions, and may not release the resources for a second CG-PUSCH corresponding to non-shaded portions.

In some embodiments, after receiving the indication information, the network device 102 stops the reception of the first CG-PUSCH after the time t1, and can continue the reception of the second CG-PUSCH or other CG-PUSCHs.

In some embodiments, the indication information is applicable to both the first CG-PUSCH and the second CG-PUSCH.

As shown in FIG. 5, the first CG-PUSCH and the second CG-PUSCH have the same periods but different initial offsets.

It is assumed that the indication information is included in the first one among the plurality of the first CG-PUSCHs, and after an ending time t1 of the first one among the plurality of the first CG-PUSCHs, the user equipment 101 can release the resources for the first CG-PUSCH corresponding to shaded portions, as well as the resources for the second CG-PUSCH corresponding to non-shaded portions.

In some embodiments, after receiving the indication information, the network device 102 stops the reception of the first CG-PUSCH and the second CG-PUSCH after time t1. If there are other corresponding CG-PUSCH resources, the network device 102 can continue the reception of other CG-PUSCHs.

In some embodiments, the characteristic parameters include at least one of the following:
a period of the CG-PUSCH;
a group identifier of the CG-PUSCH;
a priority identifier of the CG-PUSCH.

In some embodiments, the period of the second CG-PUSCH is the same as the period of the first CG-PUSCH, indicating that the indication information is applicable to both the first CG-PUSCH and the second CG-PUSCH.

In some embodiments, the priority identifier of the second CG-PUSCH is the same as the priority identifier of the first CG-PUSCH, indicating that the indication information is applicable to both the first CG-PUSCH and the second CG-PUSCH.

In some embodiments, the group identifier of the second CG-PUSCH is the same as the group identifier of the first CG-PUSCH, indicating that the indication information is applicable to both the first CG-PUSCH and the second CG-PUSCH.

According to embodiments of the present disclosure, the indication information sent by the user equipment 101 can be applicable to one or more CG-PUSCHs, so that the network device 102 can stop the reception of the one or more CG-PUSCHs, so as to save the energy consumption.

Based on the same concept as the above method embodiments, embodiments of the present disclosure also provide an apparatus for sending indication information, which can have the function of the user equipment 101 in the above method embodiments and can be used to execute the steps provided by the user equipment 101 in the above method embodiments. The function can be implemented through hardware, or by executing corresponding software through software or hardware. The hardware or software includes one or more modules corresponding to the above functions.

In some embodiments, the apparatus 800 shown in FIG. 8 can serve as the user equipment 101 involved in the above method embodiments and execute the steps executed by the user equipment 101 in the above method embodiments. As shown in FIG. 8, the apparatus 800 can include a transceiver module 801. The transceiver module 801 can be used to support the communication conducted by the communication device.

When executing the steps implemented by the user equipment 101, the transceiver module 801 is configured to send indication information to the network device in the case that the network device configures a configured grant Physical Uplink Shared Channel (CG-PUSCH) resource for the user equipment. The indication information is configured to indicate release of the CG-PUSCH resource by the user equipment.

In some embodiments, the transceiver module 801 is further configured to include configured grant Uplink Control Information (CG-UCI) in the CG-PUSCH, and the CG-UCI includes the indication information.

In some embodiments, when the CG-PUSCH is the first type of CG-PUSCH, the configuration information corresponding to the resource for the first type of CG-PUSCH becomes invalid after the indication information is sent.

In some embodiments, when the CG-PUSCH is the second type of CG-PUSCH, the configuration information corresponding to the resource for the second type of CG-PUSCH is deactivated after the indication information is sent.

In some embodiments, when the network device configures multiple sets of CG-PUSCH resources for the user equipment, the indication information is configured to indicate the release of all CG-PUSCH resources.

In some embodiments, when the network device configures multiple sets of CG-PUSCH resources for the user equipment, the indication information is configured to indicate the release of CG-PUSCH resources for a first part of CG-PUSCHs.

In some embodiments, the indication information includes N bits, and the N bits are used to indicate an index of a carrier to which the first part of CG-PUSCHs belong.

In some embodiments, the indication information includes N bits, and the N bits are used to indicate an index of the configuration information corresponding to the first part of CG-PUSCHs.

In some embodiments, the first part of CG-PUSCHs include a first CG-PUSCH including the indication information.

In some embodiments, the first part of CG-PUSCHs include a first CG-PUSCH including the indication information, and a second CG-PUSCH having the same characteristic parameters as the first CG-PUSCH.

In some embodiments, the characteristic parameters include at least one of the following:
a period of the CG-PUSCH;
a group identifier of the CG-PUSCH;
a priority identifier of the CG-PUSCH.

In some embodiments, a valid starting time of the indication information is one of the following:
an end time of the first CG-PUSCH including the indication information;
a time postponed from the ending time of the first CG-PUSCH by a first duration.

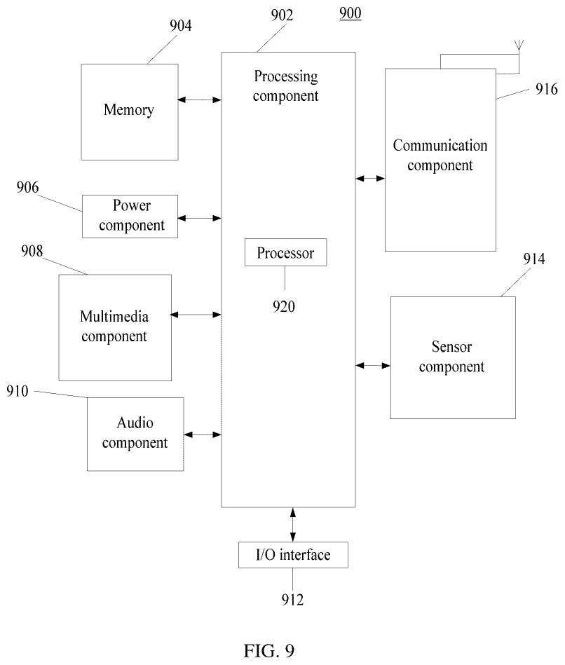

When the apparatus for receiving the configuration information is the user equipment 101, the structure of the apparatus can also be as shown in FIG. 9. The device 900 can be a mobile phone, a computer, a digital broadcasting terminal, a messaging device, a game console, a tablet device, a medical device, a fitness device, a personal digital assistant, etc.

Referring to FIG. 9, the device 900 can include at least one of the following components: a processing component 902, a memory 904, a power component 906, a multimedia component 908, an audio component 910, an input/output (I/O) interface 912, a sensor component 914, and a communication component 916.

The processing component 902 typically controls the overall operation of the device 900, such as operations associated with display, telephone call, data communication, camera operation, and recording operations. The processing component 902 may include one or more processors to execute instructions to complete all or part of the methods described above. In addition, the processing component 902 may include one or more modules to facilitate interactions between the processing component 902 and other components. For example, the processing component 902 may include a multimedia module to facilitate the interaction between the multimedia component 908 and the processing component 902.

The memory 904 is configured to store various types of data to support operations on the device 900. Examples of such data include instructions, contact data, phone book data, messages, pictures, videos, and the like for any application or method operating on the device 900. The memory 904 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 906 provides power for various components of the device 900. The power component 906 can include a power management system, one or more power supplies, and other components associated with generating, managing, and distributing power for the device 900.

The multimedia component 908 includes a display screen providing an output interface between the device 900 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 908 includes a front camera and/or a rear camera. When the device 900 is in operation mode, such as shooting mode or video mode, the front camera and/or rear camera can receive external multimedia data. Each front camera and rear camera can be a fixed optical lens system or have focal length and optical zoom capability.

The audio component 910 is configured to output and/or input audio signals. For example, the audio component 910 includes a microphone (MIC), which is configured to receive an external audio signal when the device 900 is in an operation mode, such as a calling mode, a recording mode, and a voice recognition mode. The received audio signal may be further stored in memory 904 or transmitted via communication component 916. In some embodiments, the audio component 910 also includes a speaker for outputting audio signals.

The I/O interface 912 provides an interface between the processing component 902 and peripheral interface modules, which can be a keyboard, click wheel, button, etc. These buttons may include, but are not limited to, the Home button, Volume button, Start button, and Lock button.

The sensor component 914 includes one or more sensors for providing various aspects of condition evaluation for the device 900. For example, the sensor component 914 can detect an open/closed state of the device 900, relative positioning of the components. The component is, for example, a display and a keypad of the device 900. The sensor component 914 can also detect changes in the position of the device 900 or one component of the device 900, presence or absence of the user's contact with the device 900, orientation or acceleration/deceleration of the device 900 and temperature change of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the device 900 and other devices. The device 900 can access wireless networks based on communication standards, such as WiFi, 2G or 3G, or a combination thereof. In some embodiments, the communication component 916 receives a broadcast signal or broadcast related information from an external broadcast management system via a broadcast channel. In some embodiments, the communication component 916 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 900 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 904 including instructions, which can be executed by the processor 920 of the device 900 to complete above methods. For example, the non-transitory computer-readable storage medium can be ROM, random access memory (RAM), CD-ROM, tapes, floppy disks, optical data storage devices, etc.

Based on the same concept as the above method embodiments, embodiments of the present disclosure also provide an apparatus for receiving indication information, which can have the function of the network device 102 in the above method embodiments and can be used to execute the steps provided by the network device 102 in the above method embodiments. The function can be implemented through hardware, or by executing corresponding software through software or hardware. The hardware or software includes one or more modules corresponding to the above functions.

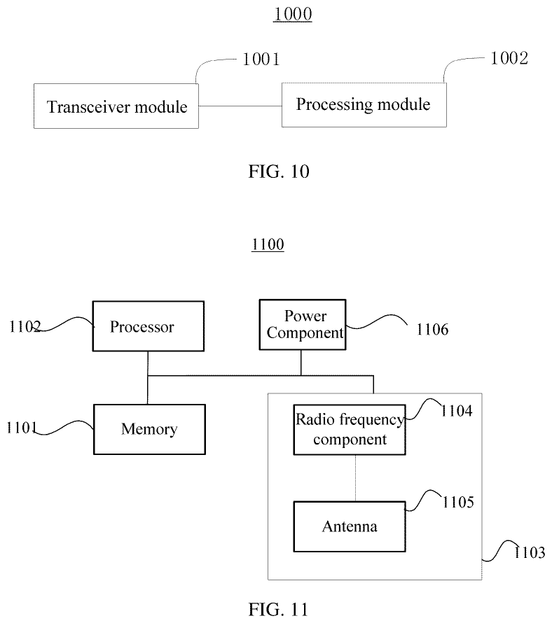

In some embodiments, the apparatus 1000 shown in FIG. 10 can serve as the network device 102 involved in the above method embodiments and execute the steps executed by the network device 102 in the above method embodiments. As shown in FIG. 10, the apparatus 1000 can include a transceiver module 1001 and a processing module 1002 coupled to each other. The transceiver module 1001 can be used to support the communication conducted by the communication device. The transceiver module 1001 can have wireless communication function, such as wirelessly communicating with other communication devices through a wireless air interface. The processing module 1002 can be used by the communication device to perform processing operations, such as generating information/messages that need to be sent, or processing received signals to obtain information/messages.

When executing the steps implemented by the network device 102, the transceiver module 1001 is configured to receive indication information sent by the user equipment. The indication information is configured to indicate release of the CG-PUSCH resource by the user equipment.

The processing module 1002 is configured to stop reception of the CG-PUSCH corresponding to the CG-PUSCH resource after receiving the indication information.

In some embodiments, the transceiver module 1001 is further configured to receive the CG-UCI included in the CG-PUSCH, which includes the indication information.

In some embodiments, the processing module 1002 is further configured to stop the reception of the CG-PUSCH corresponding to the CG-PUSCH resource from a valid starting time of the indication information.

In some embodiments, the valid starting time is one of the following:
an ending time of the first CG-PUSCH including the indication information;
a time postponed from the ending time of the first CG-PUSCH by a first duration.

In some embodiments, processing module 1002 is further configured to abandon, after receiving the indication information, to send Downlink Control Information (DCI) configured to deactivate the configuration information corresponding to the CG-PUSCH when the CG-PUSCH is the second type of CG-PUSCH.

In some embodiments, when the indication information is configured to indicate the release of all CG-PUSCH resources, the processing module 902 is further configured to stop the uplink reception of all CG-PUSCHs configured by the network device.

In some embodiments, when the indication information is configured to indicate the release of CG-PUSCH resources for the first part of CG-PUSCHs, the processing module 1002 is further configured to stop the uplink reception of the first part of CG-PUSCHs.

In some embodiments, the first part of CG-PUSCHs include at least one of the following:
a first CG-PUSCH including the indication information;
a second CG-PUSCH having the same characteristic parameters as the first CG-PUSCH.

In some embodiments, the characteristic parameters include at least one of the following:
a period of the CG-PUSCH;
a group identifier of the CG-PUSCH;
a priority identification of the CG-PUSCH.

In some embodiments, the processing module 1002 is further configured to determine the first part of CG-PUSCHs based on the indication information.

In some embodiments, the indication information includes N bits, and the N bits are configured to indicate one of the following:
an index of a carrier to which the first part of CG-PUSCHs belong;
an index of configuration information corresponding to the first part of CG-PUSCHs.

When the communication device is a network device 102, the structure of the network device 102 can also be as shown in FIG. 11. A base station is taken as an example to illustrate the structure of the communication device. As shown in FIG. 11, the device 1100 includes a memory 1101, a processor 1102, a transceiver component 1103, and a power component 1106. In some embodiments, the memory 1101 is coupled to the processor 1102 and can be used to store the necessary programs and data for the communication device 1100 to implement various functions. The processor 1102 is configured to support the communication device 1100 to perform the corresponding functions in the above methods, which can be implemented by calling the programs stored in the memory 1101. The transceiver component 1103 can be a wireless transceiver, which can be used to support the communication device 1100 to receive signaling and/or data through a wireless air interface, as well as to send signaling and/or data. The transceiver component 1103 can also be referred to as a transceiver unit or a communication unit. The transceiver component 1103 can include a radio frequency component 1104 and one or more antennas 1105, where the radio frequency component 1104 can be a remote radio unit (RRU), specifically used for transmitting radio frequency signals and converting radio frequency signals to baseband signals. The one or more antennas 1105 can be used for radiating and receiving radio frequency signals.

When the communication device 1100 needs to send data, the processor 1102 can perform baseband processing on the data to be sent and output the baseband signals to the radio frequency unit. The radio frequency unit processes the baseband signals and sends the baseband signals in the form of electromagnetic waves through the antenna. When data is sent to the communication device 1100, the radio frequency unit receives the radio frequency signals through the antenna, converts the radio frequency signals into baseband signals, and outputs the baseband signals to the processor 1102. The processor 1102 converts the baseband signals into data and processes the data.

After considering the specification and practicing the embodiments disclosed herein, those skilled in the art will easily come up with other embodiments of the present disclosure. The present disclosure is intended to cover any variations, uses, or adaptive changes of the present disclosure that follow the general principles of the present disclosure and include common knowledge or customary technical means in the art that are not disclosed herein. The specification and embodiments are considered as exemplary only, and the true scope and spirit of the present disclosure are indicated by the appended claims.

It should be understood that the present disclosure is not limited to the precise structure described above and shown in the drawings, and various modifications and changes can be made without departing from the scope thereof. The scope of the present disclosure is limited only by the appended claims.

### INDUSTRIAL APPLICABILITY

In the method provided by the present disclosure, the user equipment notifies the network device that it will release the CG-PUSCH resources by sending the indication information to the network device, so that the network devices can stop the uplink reception of the CG-PUSCH based on the indication information, thereby stopping the unnecessary blind detection and the reception timely, as well as reducing the energy consumption of the network device.

1. A method for sending indication information, performed by a user equipment, the method comprising:
in the case that a network device configures a configured grant Physical Uplink Shared Channel (CG-PUSCH) resource for the user equipment, sending indication information to the network device, wherein the indication information is configured to indicate the user equipment to release the CG-PUSCH resource.

2. The method according to claim 1, wherein sending the indication information to the network device comprises:
including configured grant Uplink Control Information (CG-UCI) in a CG-PUSCH, wherein the CG-UCI comprises the indication information.

3. The method according to claim 1, wherein:
in the case that a CG-PUSCH is a first type of CG-PUSCH, configuration information corresponding to a resource for the first type of CG-PUSCH becomes invalid after the indication information is sent; and
in the case that a CG-PUSCH is a second type of CG-PUSCH, configuration information corresponding to a resource for the second type of CG-PUSCH is deactivated after the indication information is sent.

4. (canceled)

5. The method according to claim 2, wherein in the case that the network device configures multiple sets of CG-PUSCH resources for the user equipment, the indication information is configured to indicate release of all CG-PUSCH resources.

6. The method according to claim 2, wherein in the case that the network device configures multiple sets of CG-PUSCH resources for the user equipment, the indication information is configured to indicate release of the CG-PUSCH resources for a first part of CG-PUSCHs.

7. The method according to claim 6, wherein the indication information comprises N bits, and the N bits are configured to indicate at least one of:
an index of a carrier to which the first part of CG-PUSCHs belong; or
an index of configuration information corresponding to the first part of CG-PUSCHs.

8. (canceled)

9. The method according to claim 6, wherein the first part of CG-PUSCHs comprise a first CG-PUSCH comprising the indication information.

10. The method according to claim 6, wherein the first part of CG-PUSCHs comprise a first CG-PUSCH comprising the indication information, and a second CG-PUSCH having a same characteristic parameter as the first CG-PUSCH.

11. The method according to claim 10, wherein the characteristic parameter comprises at least one of:
a period of the CG-PUSCH;
a group identifier of the CG-PUSCH; or
a priority identifier of the CG-PUSCH.

12. The method according to claim 2, wherein a valid starting time of the indication information comprises one of:
an ending time of a first CG-PUSCH comprising the indication information; and
a time postponed from the ending time of the first CG-PUSCH by a first duration.

13. A method for receiving indication information, performed by a network device, the method comprising:
receiving indication information sent by a user equipment, wherein the indication information is configured to indicate the user equipment to release a configured grant Physical Uplink Shared Channel (CG-PUSCH) resource; and
stopping reception of a CG-PUSCH corresponding to the CG-PUSCH resource after receiving the indication information.

14. The method according to claim 13, wherein receiving the indication information sent by the user equipment comprises:
receiving configured grant Uplink Control Information (CG-UCI) comprised in the CG-PUSCH, wherein the CG-UCI comprises the indication information.

15. The method according to claim 14, wherein stopping the reception of the CG-PUSCH corresponding to the CG-PUSCH resource after receiving the indication information comprises:
stopping the reception of the CG-PUSCH corresponding to the CG-PUSCH resource from a valid starting time of the indication information.

16. The method according to claim 15, wherein the valid starting time comprises one of:
an ending time of a first CG-PUSCH comprising the indication information; and
a time postponed from the ending time of the first CG-PUSCH by a first duration.

17. The method according to claim 13, further comprising:
in the case that the CG-PUSCH is a second type of CG-PUSCH, abandoning, after receiving the indication information, to send Downlink Control Information (DCI) configured to deactivate configuration information corresponding to the CG-PUSCH.

18. The method according to claim 13, wherein the indication information is configured to indicate release of all CG-PUSCH resources, and
wherein stopping the reception of the CG-PUSCH corresponding to the CG-PUSCH resource comprises:
stopping uplink reception of all CG-PUSCHs configured by the network device.

19. The method according to claim 13, wherein the indication information is configured to indicate release of CG-PUSCH resources for a first part of CG-PUSCHs, and
wherein stopping the reception of the CG-PUSCH corresponding to the CG-PUSCH resource comprises:
stopping uplink reception of the first part of CG-PUSCHs.

20. The method according to claim 19, wherein the first part of CG-PUSCHs comprise at least one of:
a first CG-PUSCH comprising the indication information; or
a second CG-PUSCH having a same characteristic parameter as the first CG-PUSCH.

21.-25. (canceled)

26. A communication device, comprising:
a processor; and
a memory storing a computer program executable by the processor;
wherein the processor is configured to perform the method according to claim 1.

27. A communication device, comprising:
a processor; and
a memory storing a computer program executable by the processor;
wherein the processor is configured to perform the method according to claim 13.

28. (canceled)

29. (canceled)
